(19) United States
(12) Patent Application Publication
(10) Pub. No.: US 2012/0065970 A1
(43) Pub. Date: Mar. 15, 2012

(54) SYSTEM AND METHOD FOR PROVIDING GROUP DISCUSSIONS

(75) Inventors: Charanjit SINGH, Bridgewater, NJ (US); Mukesh Sehgal, Long Valley, NJ (US)

(73) Assignee: Sequent, Inc., Morristown, NJ (US)

(21) Appl. No.: 12/882,655

(22) Filed: Sep. 15, 2010

(51) Int. Cl. G10L 15/26; G10L 13/08

(52) U.S. Cl. 704/235; 704/260; 704/E15.043; 704/E13.011

(57) ABSTRACT

A system and method for providing a discussion, including receiving by a processor text related to a discussion; converting by the processor the text to voice; storing by the processor in a memory the converted voice; receiving by the processor voice related to the discussion; storing by the processor in the memory the received voice; receiving by the processor a request to play voice related to at least part of the discussion; and transmitting by the processor audio containing the voice identified by the request related to the at least part of the discussion.

### BACKGROUND OF THE INVENTION

1. Field of the Invention

This disclosure relates to group discussions, and more particularly to a system and method for providing group discussions.

2. Description of the Related Art

Conducting discussions with colleagues is a long proven method used by physicians to assist in the diagnosis and treatment of patients. These discussions require the participants to set aside a specific time to meet and set a mutually convenient place to gather.

With the advent of the Internet and local networks, discussion groups have been adapted to enable participants to read and reply to text-based discussions. In operation, a participant to the group discussion creates a topic for discussion. This participant types in details of the topic to be discussed and posts the topic and details to a server. The process of posting to a server is well known in the art, and can include uploading the typed in text, i.e. topic and details, to the server, which in turn makes the topic and details accessible to other participants, or members, of the discussion group. The details can be in the form of information and/or questions related to the topic. All participants of the discussion group can access and view the topics and details posted to the discussion group. A second participant can read the topics and details and can reply thereto by typing in a reply and posting the reply to the discussion group. The server can structure the topic, details and replies in chronological order for ease of review by participants. Other participants can read and reply to all previous topics, details and/or replies. The physicians who are group participants must set aside time to read through the postings (i.e. topics, details and/or replies) in order to meaningfully participate in the group discussion.

These prior art processes are both time consuming and inconvenient for the physicians, and may also result in certain postings being overlooked.

### SUMMARY OF THE INVENTION

Accordingly, the present invention has been made to solve at least the above-mentioned problems occurring in the prior art, and an object of the present invention is to provide a system and method for providing a discussion.

One embodiment of the invention provides a method for providing a discussion, including receiving by a processor text related to a discussion; converting by the processor the text to voice; storing by the processor in a memory the converted voice; receiving by the processor voice related to the discussion; storing by the processor in the memory the received voice; receiving by the processor a request to play voice related to at least part of the discussion; and transmitting by the processor audio containing the voice identified by the request related to the at least part of the discussion.

Another embodiment of the invention provides a system for providing a discussion, the system includes a processor for receiving text related to a discussion, converting the text to voice, receiving voice related to the discussion, receiving a request to play voice related to at least part of the discussion, and transmitting audio containing the voice identified by the request related to the at least part of the discussion; and a memory for storing the converted voice, and storing the received voice.

A further embodiment of the invention provides a system for providing a discussion, the system includes a processor for receiving text related to a discussion, converting the text to voice, receiving voice related to the discussion, receiving a request to play voice related to at least part of the discussion, transmitting audio containing the voice identified by the request related to the at least part of the discussion, converting the received voice to text, and posting the text and the text of the received voice to a discussion board; a memory for storing the converted voice, and storing the received voice; and a communication device for accessing the discussion board, receiving from a user text to post on the discussion board, receiving from a user a post command, and transmitting to the processor the text to post as text related to the discussion.

### BRIEF DESCRIPTION OF THE DRAWINGS

The accompanying drawings, referred to herein and constituting a part hereof, illustrate the preferred embodiments of the bearing assembly of the present invention and, together with the description, serve to explain the principles of the invention.

FIG. 1 is a diagram illustrating a system for providing group discussions according to an embodiment of the present invention.

FIG. 2 is a diagram illustrating processes for a system for providing group discussions according to an embodiment of the present invention.

FIG. 3 is a diagram illustrating a communication device to which the present invention has been applied.

FIGS. 4A and 4B are a flowchart illustrating a method for providing a discussion according to an embodiment of the present invention.

FIG. 5 is a flowchart illustrating a method for providing a discussion according to an embodiment of the present invention.

### DETAILED DESCRIPTION OF PREFERRED EMBODIMENTS

Various embodiments of the invention are described hereinafter with reference to the figures. Elements of like structures or function are represented with like reference numerals throughout the figures. The figures are only intended to facilitate the description of the invention or as a guide on the scope of the invention. In addition, an aspect described in conjunction with a particular embodiment of the invention is not necessarily limited to that embodiment and can be practiced in conjunction with any other embodiments of the invention. In the following description of the present invention, a detailed description of known functions and configurations incorporated herein will be omitted when it may make the subject matter of the present invention rather unclear.

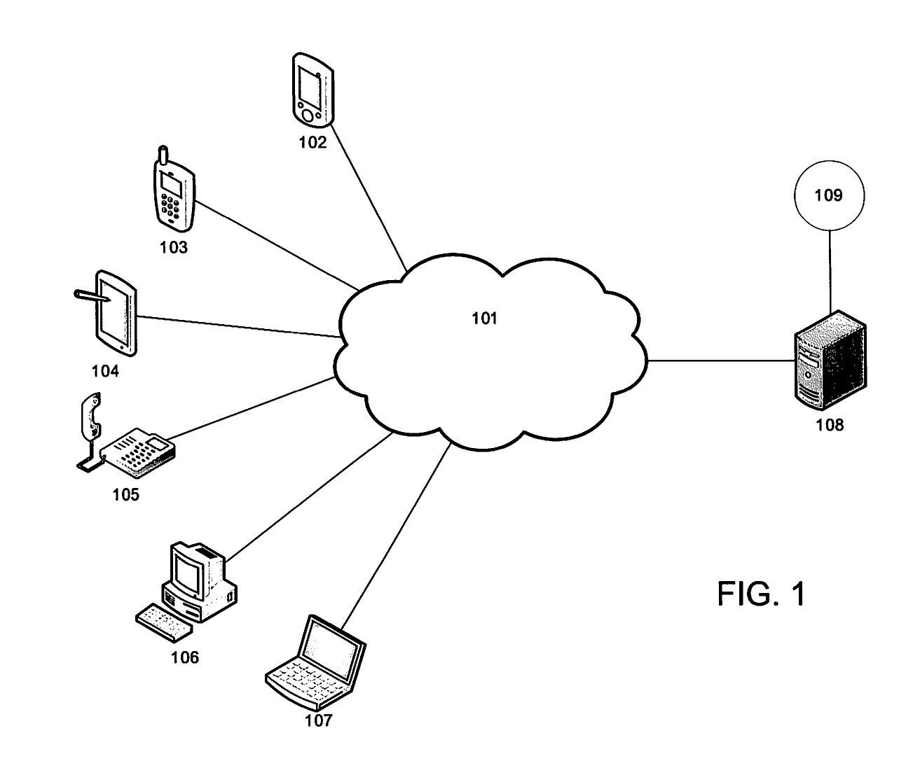

FIG. 1 is a diagram illustrating a system for providing group discussions according to an embodiment of the present invention. Shown in FIG. 1 are network 101, communication devices 102-107, and processor 108. Network 101 can be a Local Area Network (LAN), a Wide Area Network (WAN), the Internet, or other network. A communication device can include Personal Digital Assistant (PDA) 102, smart phone 103, electronic tablet 104, telephone 105, desktop computer 106, and laptop computer 107. Other communication devices are contemplated. Communication devices 102-107 communicate with processor 108 through network 101. Processor 108 is connected to a memory 109 for storing program data, voice data, and text data.

Processor 108 can be included in a health records server for storing Electronic Medical Record (EMR) data of multiple patients and multiple physicians as part of a system for providing electronic records. Such a system is disclosed in U.S. patent application Ser. No. 12/881,711, filed on Sep. 14, 2010, entitled “System And Method For Providing Electronic Records”, the entire contents of which are hereby incorporated by reference.

The present invention can effectively communicate the discussion to all of the described communication devices. For example, electronic tablet 104 is a device that may support only text communications (i.e. does not support voice communications) and therefore requires all discussions to be in text format, but telephone 105 is a device that may support only voice based communications (i.e. does not support text communications) and therefore requires all discussions to be in voice format. Other communication devices may support both text and voice formats, e.g. a PDA 102 or laptop 107.

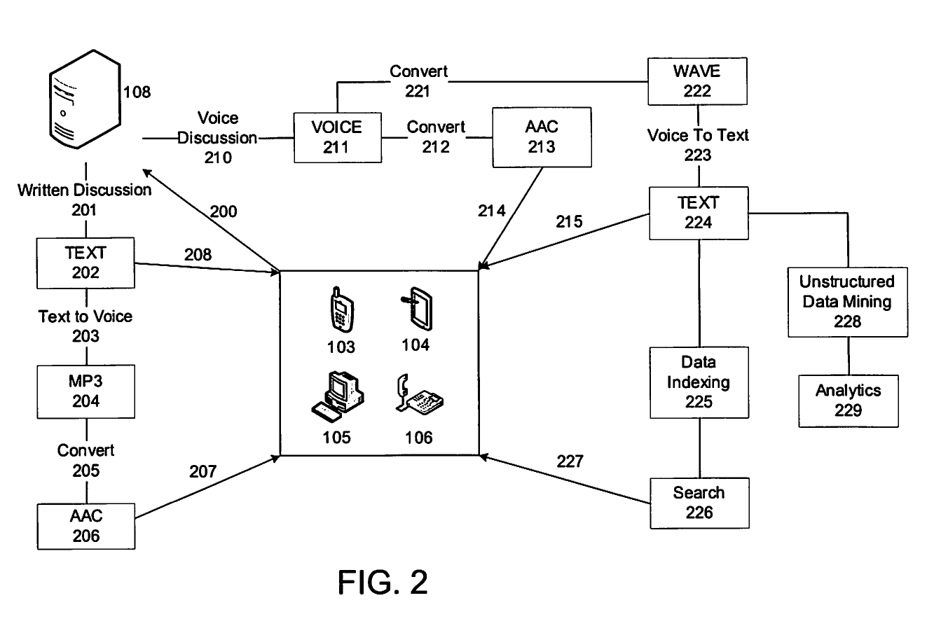

FIG. 2 is a diagram illustrating processes for a system for providing group discussions according to an embodiment of the present invention. Shown in FIG. 2 are communication devices 103-106 that communicate with processor 108 through one of the described networks (not shown). If text is received, processor 108 follows written discussion path 201 to process the text, and if voice is received, processor 108 follows voice discussion path 210 to process the voice. At 200 a communication device 103-106 transmits and processor 108 receives either text or voice as part of a discussion. Processor 108 determines whether text or voice is received and proceeds to written discussion path 201 or voice discussion path 210.

In the written discussion path 201, at 202 processor 108 stores the text 202. Upon a request from a communication device for display of text of all or part of a discussion, processor 108 can transmit at 208 the text of the requested discussion to the communication device. At 203 the text is converted to voice. Converting text to voice and converting voice to text are well known in the art and will not be described in detail herein. The voice file 204 is stored in the processor 108. In one embodiment of the present invention the format into which the voice can be converted is a Moving Picture Experts Group (MPEG)-1 or MPEG-2 Audio Layer 3 (MP3) format. Other audio file formats can be used and are contemplated. The voice file 204 is subjected to another conversion at 205 into an Advanced Audio Coding (AAC) format 206. The AAC format is used because all communication devices 102-107 for audio playback support AAC format. Other universal playback formats can be used and are contemplated. Upon a request from a communication device for playback of all or part of a discussion, processor 108 can transmit at 207 an audio file containing the requested discussion to the communication device in AAC format for playback.

In the voice discussion path 210, at 200 processor 108 stores the voice 211. The voice can be stored as Flash Video (FLV), MPEG-4 (MP4) or Adaptive Multi-Rate (AMR) formats. Other formats are contemplated. Whichever format is used to store the voice, at 212 processor 108 converts the voice to AAC format for later playback. Upon a request from a communication device for playback of all or part of a discussion, processor 108 can transmit at 214 an audio file containing the requested discussion to the communication device in AAC format for playback.

In addition, after the voice 211 is stored, at 221 processor 108 can convert the voice 211 to a wave format. Wave format is used due to its ability to be easily converted to text. Other formats can be used and are contemplated. At 222, processor 108 stored the wave file. At 223, processor 108 converts the wave file to text, and stores the text at 224. Upon a request from a communication device for display of text of all or part of a discussion, processor 108 can transmit at 215 the text of the requested discussion to the communication device.

At 225, processor 108 performs data indexing on the text stored at 202 and 224. Once the data is indexed, at 226 a search of the stored data can be requested by a communication device and the results of a search can be provided back to the communication device. At 227, processor 108 transmits the results of the search to the communication device. In addition, processor 108 can perform at 228 data mining and at 229 analytics on the text stored at 202 and 224. Data mining can be performed using industry standard tools, and can be used to determine topics of interest for participants and can also be used to enhance profiles of discussion participants.

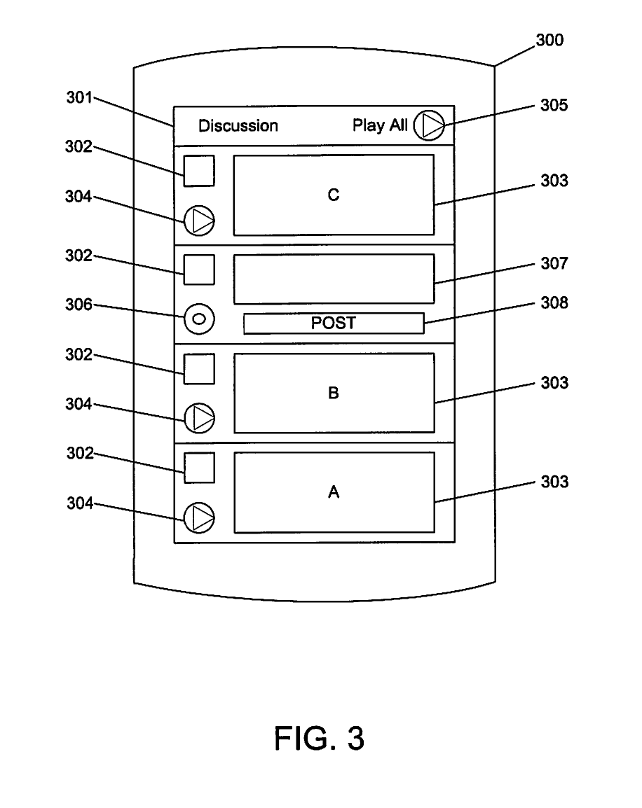

FIG. 3 is a diagram illustrating a communication device to which the present invention has been applied. Shown in FIG. 3 is smart phone 300 that includes a display area 301. Although smart phone 300 is displayed, it will be understood to those skilled in the art that the present invention can be modified to apply to other types of communication devices. A discussion is displayed within display area 301. The discussion includes postings A, B and C 303. Each posting 303 has a respective poster 302 identified therewith. Each posting 303 also has associated therewith a respective play single posting button 304. Also shown in FIG. 3 are a play all button 305, a record voice button 306, a text input box 307 and a post button 308. It is noted that for devices that only process audio information, e.g. a telephone, the present invention is equipped with a standard telephone menu program to assist in identifying the “Play All” or single post “Play” and in assisting a caller to record and post a posting.

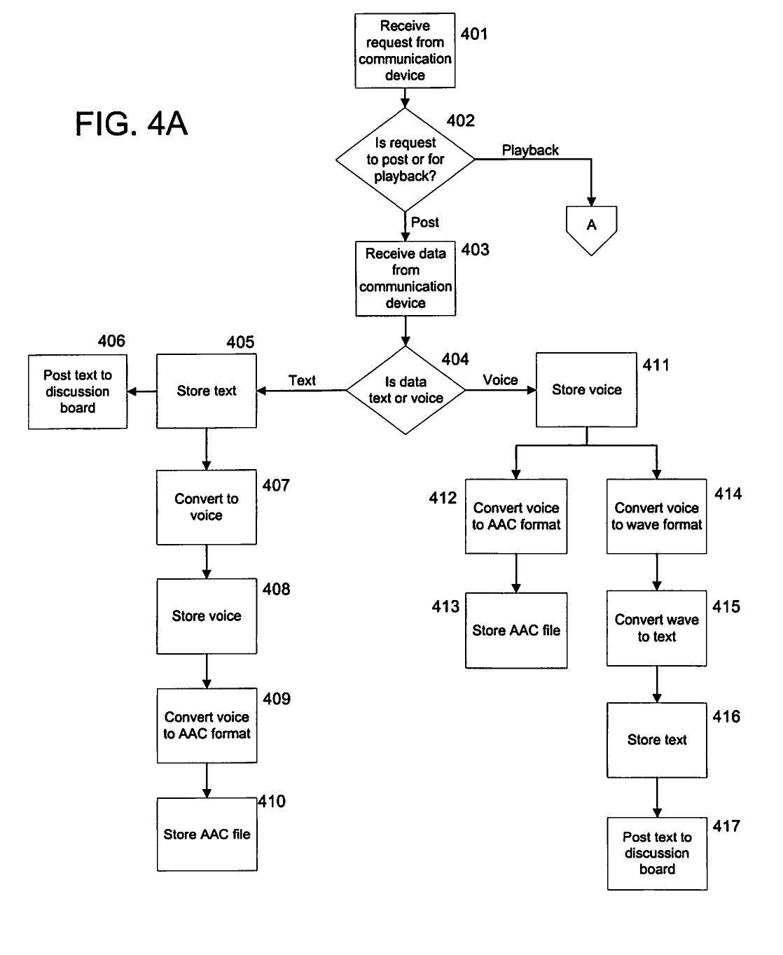

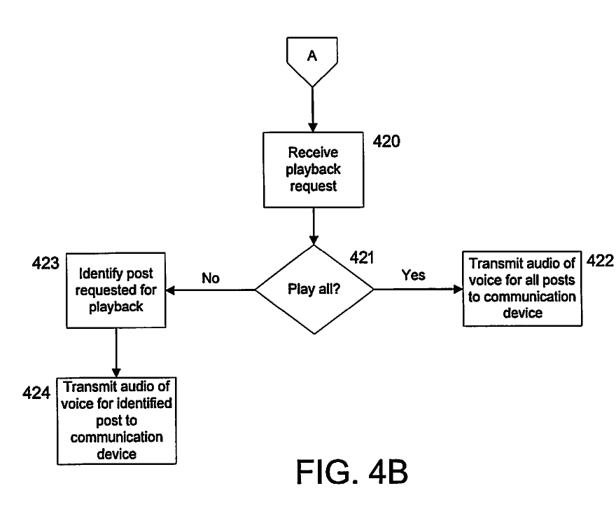

FIGS. 4A and 4B are a flowchart illustrating a method for providing a discussion according to an embodiment of the present invention.

In FIG. 4A, in step 401 processor 108 receives a request for a communication device. In step 402 processor 108 determines if request is for a post or a playback. If the request is for a post, in step 403 processor 108 receives post data from communication device. In step 404 processor 108 determines if the post data is text data or voice data. If the post data is text data, in step 405 processor 108 stores the text data. In step 406 processor 108 posts the text data to the discussion board. In step 407 processor 108 converts the text data to voice data. In step 408 processor 108 stores the voice data. In step 409 processor 108 converts the voice data into AAC format. And in step 410 processor 108 stores the AAC formatted data.

If in step 404 processor 108 determines that the data is voice data, in step 411 processor 108 stores the voice data. In step 412 processor 108 converts the voice data to AAC format. And in step 410 processor 108 stores the AAC formatted data. In step 414 processor 108 converts the voice data to wave format. In step 415 processor 108 converts the wave data into text. In step 416 processor 108 stores the text data. And in step 417 processor 108 posts the text data to the discussion board.

If in step 402 processor 108 determines that the request is for a playback, the process proceeds to FIG. 4B. In step 420 processor 108 receives a playback request from a communication device. In step 421 processor 108 determines if the playback request is a “Play All” playback request. If the playback request is a “Play All” playback request, in step 422 processor 108 transmits audio of the voice for all of the posts to the communication device. If the playback request is not a “Play All” playback request, in step 423 processor 108 identifies the post requested to playback. And in step 424 processor 108 transmits audio of the voice for the identified post to the communication device.

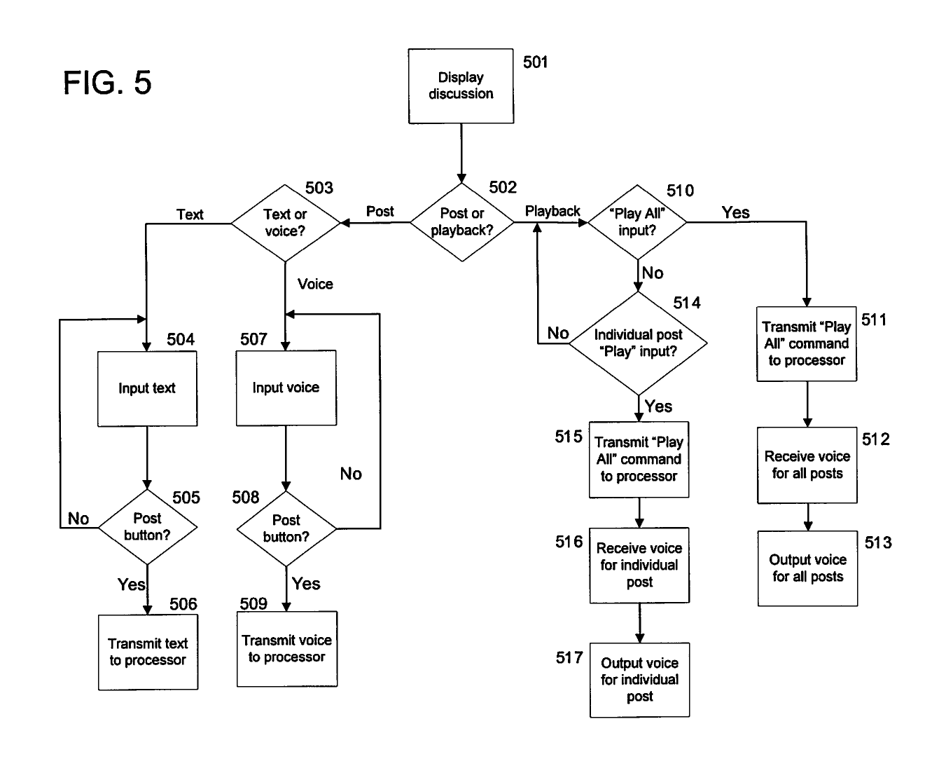

FIG. 5 is a flowchart illustrating a method for providing a discussion according to an embodiment of the present invention. In step 501 the communication device displays a discussion. In step 502 the communication device receives a post or a playback command from a user. If the command is a post command, in step 503 the communication device determines is the post command is for posting text or voice. If the post command is for a text post, in step 504 the communication device receives text input by a user. In step 505 the communication device determines is a post command is input. If the post command is input, in step 506 the communication device transmits the entered text to processor 108 for processing. If the post command is for a voice post, in step 507 the communication device receives voice input by a user. The use of a record function using record voice button 306 can be utilized. In step 508 the communication device determines is a post command is input. If the post command is input, in step 509 the communication device transmits the entered voice to processor 108 for processing.

If in step 502 the communication device determines that the command is a playback command, in step 510 the communication device determines if a “Play All” command is input. If the “Play All” command is input, in step 511 the communication device transmits the “Play All” command to processor 108. In step 512 the communication device receives the voice data for all of the posts. And in step 513 the communication device outputs the audio of the voice data for all of the posts. If the “Play All” command is not input, in step 514 the communication device determines if a “Play” command for an individual post is input. If the “Play” command for and individual post is input, in step 515 the communication device transmits the “Play” command for the individual post to processor 108. In step 516 the communication device receives the voice data for the individual post. And in step 517 the communication device outputs the audio of the voice data for the individual post.

The present invention can provide a user with the ability to interact with a discussion board using either text or voice or both. The present invention reduces the time required to interact with the discussion board and also provides a great convenience to the user.

While the invention has been described with reference to a number of exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to any particular exemplary embodiment disclosed herein.

What is claimed is:

1. A method for providing a discussion, comprising the steps of:
receiving by a processor text related to a discussion;
converting by the processor the text to voice;
storing by the processor in a memory the converted voice;
receiving by the processor voice related to the discussion;
storing by the processor in the memory the received voice;
receiving by the processor a request to play voice related to at least part of the discussion; and
transmitting by the processor audio containing the voice identified by the request related to the at least part of the discussion.

2. The method of claim 1, further comprising:
storing the text related to the discussion;
converting the received voice to text and storing the text of the received voice; and
posting the text and the text of the received voice to a discussion board.

3. The method of claim 2, further comprising:
accessing by a communication device the discussion board;
receiving by the communication device from a user text to post on the discussion board;
receiving by the communication device from a user a post command; and
transmitting by the communication device to the processor the text to post as text related to the discussion.

4. The method of claim 2, further comprising:
accessing by a communication device the discussion board;
receiving by the communication device from a user voice to post on the discussion board;
receiving by the communication device from a user a post command; and
transmitting by the communication device to the processor the voice to post as voice related to the discussion.

5. The method of claim 1, further comprising converting the converted voice and the receive voice to a universal playback format.

6. The method of claim 2, further comprising:
accessing by a communication device the discussion board;
receiving by the communication device from a user the request to play the voice related to the at least part of the discussion;
transmitting by the communication device to the processor the request to play the voice related to the at least part of the discussion;
receiving by the communication device from the processor the audio containing the voice identified by the request related to the at least part of the discussion; and
outputting by the communication device the audio containing the voice identified by the request related to the at least part of the discussion.

7. The method of claim 6, further comprising:
determining by the processor if the request to play the voice related to the at least part of the discussion is a request to play voice related to all of the discussion;
transmitting by the processor to the communication device audio containing voice of all of the discussion;
receiving by the communication device from the processor the audio containing the voice of all of the discussion; and
outputting by the communication device the audio containing the voice of all of the discussion.

8. A system for providing a discussion, the system comprising:
a processor for receiving text related to a discussion, converting the text to voice, receiving voice related to the discussion, receiving a request to play voice related to at least part of the discussion, and transmitting audio containing the voice identified by the request related to the at least part of the discussion; and
a memory for storing the converted voice, and storing the received voice.

9. The system of claim 8, wherein the processor converts the received voice to text, and the processor posts the text and the text of the received voice to a discussion board.

10. The system of claim 9, wherein the memory stores the text of the received voice and the text related to the discussion.

11. The system of claim 9, further comprising:
a communication device for accessing the discussion board, receiving from a user text to post on the discussion board, receiving from a user a post command, and transmitting to the processor the text to post as text related to the discussion.

12. The system of claim 9, further comprising:
a communication device for accessing the discussion board, receiving from a user voice to post on the discussion board, receiving from a user a post command, and transmitting to the processor the voice to post as voice related to the discussion.

13. The system of claim 8, wherein the processor converts the converted voice and the receive voice to a universal playback format.

14. The system of claim 9, wherein the communication device accesses the discussion board, receives from a user the request to play the voice related to the at least part of the discussion, transmits to the processor the request to play the voice related to the at least part of the discussion, receives from the processor the audio containing the voice identified by the request related to the at least part of the discussion, and outputs the audio containing the voice identified by the request related to the at least part of the discussion.

15. The system of claim 14, wherein the processor determines if the request to play the voice related to the at least part of the discussion is a request to play voice related to all of the discussion, and transmits to the communication device audio containing voice of all of the discussion.

16. The system of claim 15, wherein the communication device receives from the processor the audio containing the voice of all of the discussion, and outputs the audio containing the voice of all of the discussion.

17. A system for providing a discussion, the system comprising:
a processor for receiving text related to a discussion, converting the text to voice, receiving voice related to the discussion, receiving a request to play voice related to at least part of the discussion, transmitting audio containing the voice identified by the request related to the at least part of the discussion, converting the received voice to text, and posting the text and the text of the received voice to a discussion board;
a memory for storing the converted voice, and storing the received voice; and
a communication device for accessing the discussion board, receiving from a user text to post on the discussion board, receiving from a user a post command, and transmitting to the processor the text to post as text related to the discussion.

18. The system of claim 17, wherein the memory stores the text of the received voice and the text related to the discussion.

19. The system of claim 17, wherein the communication device receives from a user voice to post on the discussion board, receives from a user a post command, and transmits to the processor the voice to post as voice related to the discussion.

20. The system of claim 17, wherein the communication device accesses the discussion board, receives from a user the request to play the voice related to the at least part of the discussion, transmits to the processor the request to play the voice related to the at least part of the discussion, receives from the processor the audio containing the voice identified by the request related to the at least part of the discussion, and outputs the audio containing the voice identified by the request related to the at least part of the discussion.

21. The system of claim 20, wherein the processor determines if the request to play the voice related to the at least part of the discussion is a request to play voice related to all of the discussion, and transmits to the communication device audio containing voice of all of the discussion.

22. The system of claim 21, wherein the communication device receives from the processor the audio containing the voice of all of the discussion, and outputs the audio containing the voice of all of the discussion.
